(19) United States
(12) Patent Application Publication
(10) Pub. No.: US 2021/0179491 A1
(43) Pub. Date: Jun. 17, 2021

(54) READY-MIX CONCRETE PRODUCTION UTILIZING CARBON CAPTURE AND RELATED SYSTEMS

(71) Applicant: MEEDL68 LP, Las Vegas, NV (US)

(72) Inventors: RENE E. PEINADO, San Francisco, CA (US); ZACHARY CHARLES GRASLEY, College Station, CA (US)

(73) Assignee: MEEDL68 LP, Las Vegas, NV (US)

(21) Appl. No.: 17/044,759

(22) PCT Filed: Apr. 4, 2019
(86) PCT No.: PCT/US2019/025803

§ 371 Date: Oct. 1, 2020

Related U.S. Application Data
(60) Provisional application No. 62/652,679, filed on Apr. 4, 2018.

(30) Foreign Application Priority Data
Apr. 4, 2018 (US) 62652679

(51) Int. Cl. C04B 7/36; C02F 1/66; C04B 40/00; F25J 3/02; B63B 35/44

(52) U.S. Cl. CPC C04B 7/365; C02F 1/66; C04B 40/0039; C02F 2101/10; F25J 3/0266; B63B 35/44; C04B 7/367

(57) ABSTRACT

An illustrative method for CO2 sequestration may include the step of sequestering at least a portion of a CO2 gas emitted during operation of the ready-mix concrete production system in (i) a ready-mix concrete produced by the read-mix concrete production system, and/or (ii) calcium carbonate formed by processing water used during operation of the ready-mix concrete production and delivery system.

### TECHNICAL FIELD

This disclosure relates generally to methods and systems for capturing carbon dioxide released during power generation. In some aspects, the disclosure relates to carbon dioxide capture during power generation for ready-mix concrete production and delivery.

### RELATED ART

Concrete is a building material used through the world for a multitude of construction projects such as bridges, tunnels, support walls, erosion barriers, trenches, retainment structures, commercial and residential structure, roads, underwater foundations, etc. It is a material made mainly from naturally occurring components such as aggregates, cement, and water. Conventionally, concrete is transported from a batching plant to a pour site using vehicle-mounted transit mixers. Like many other industrial processes, carbon dioxide (CO2) emissions invariably occur during the manufacture and transportation of ready-mix concrete.

The present disclosure addresses the need to capture CO2 emissions associated with the manufacture and delivery of ready-mix concrete as well as during other activities.

### SUMMARY OF THE DISCLOSURE

In aspects, the present disclosure provides a method of producing ready-mix concrete. The method may include the steps of positioning a facility on a body of water, the facility being configured to produce and deliver ready-mix concrete, wherein an emission that includes carbon dioxide (CO2) is generated during operation of the facility; producing the ready-mix concrete at the facility; generating a process water by using a feed water during production of the ready-mix concrete, the process water including at least, calcium, and silica ions; separating the CO2 from the generated emission; liquefying the separated CO2 by compressing the CO2; adding at least a portion of the separated CO2 to the process water; and adding at least a portion of the separated CO2 to the ready-mix concrete produced at the facility.

In further aspects, the present disclosure provides a system for producing and delivering of ready-mix concrete. The system may include a facility configured to be positioned on a body of water, wherein an emission that includes carbon dioxide (CO2) is generated during operation of the facility; a ready-mix concrete production system disposed on the facility and configured to produce the ready-mix concrete, the ready-mix concrete production system generating a process water by using a feed water during production of the ready-mix concrete, the process water including at least, calcium, and silica ions; a ready-mix concrete delivery system configured to deliver the produced ready-mix concrete to a selected pour point; and a carbon capture system disposed on the vessel. The carbon capture system may include a least one offtake receiving the emission, a capture/liquefaction unit configured to separate a CO2 from the received emission and liquefy the separated CO2, and at least one container configured to store the separated CO2. The carbon capture system may be configured to add least a portion of the stored CO2 to the process water, and add at least a portion of the stored CO2 to the ready-mix concrete produced at the facility.

In still further aspects, the present disclosure provides ready-mix concrete production methods and related systems. An illustrative method may include the step of sequestering at least a portion of a CO2 gas emitted during operation of a ready-mix concrete production system in at least one of: (i) a ready-mix concrete produced by the ready-mix concrete production system, and (ii) calcium carbonate formed by processing water used during operation of the ready-mix concrete production system.

In still further aspects, the present disclosure provides methods and related systems for capturing and sequestering CO2 emitted during power generation occurring onboard vessels. An illustrative method may include the step of capturing at least a portion of a CO2 gas emitted during operation of a power generation system on a vessel. The captured CO2 may be compressed, and optionally liquefied, and stored.

### BRIEF DESCRIPTION OF THE FIGURES

FIG. 1 illustrates one non-limiting embodiment of a facility that may use CO2 carbon capture methods as described in the present disclosure;

FIG. 2 illustrates one non-limiting embodiment of a carbon capture method according to the present disclosure;

FIG. 3 illustrates one non-limiting embodiment of a process that uses CO2 as a feed;

FIG. 4 illustrates one non-limiting embodiment of a ready-mix concrete delivery system method according to the present disclosure;

FIG. 5 illustrates another non-limiting embodiment of a ready-mix concrete delivery system method according to the present disclosure; and

FIG. 6 illustrates one non-limiting embodiment of a facility according to the present disclosure that is adapted for use in delivering ready-mix concrete to a seabed.

### DETAILED DESCRIPTION OF THE DISCLOSURE

Generally, aspects of the present disclosure capture some or all of the carbon dioxide (CO2) emitted at a facility prior to or during power generation. For simplicity, the present disclosure is directed to a non-limiting example of power generation during operation of a ready-mix concrete production and delivery system. Illustrative operations include, but are not limited to, operating propulsion machinery, generators, turbines, pumps, processors, mixers, motors, etc. By “sequester” or “capture,” it is meant that the CO2 is bound in a liquid or solid media that prevents the CO2 from entering the atmosphere for a long period of time, e.g., a hundred years or more. Illustrative carbon capture systems and associated facilities for producing ready-mix concrete are discussed below.

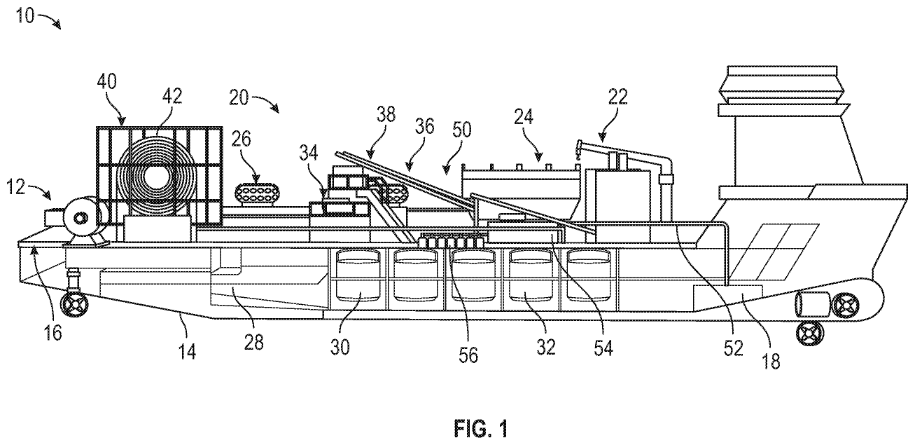

Referring to FIG. 1, there is schematically illustrated a ready-mix concrete production facility 10 according to the present disclosure. In some embodiments, the facility 10 may be a water craft, or a waterborne facility as illustrated. In other embodiments not illustrated, the facility 10 may be a land-based system. The facility 10 may include a vessel 12 having a hull 14, one or more decks 16, and a power generation system 18. The facility 10 also includes an integrated ready-mix concrete production system 20, which is described in further detail below.

In one embodiment, the ready-mix concrete production system 20 may include one or more containers 22 for holding cement mix, one or more containers 24 for holding aggregate, one or more containers 26 for holding additives, one or more containers 28 for holding water, one or more containers 30 for holding waste water/process water, and one or more containers 32 for holding cement. These components are conveyed and processed by equipment such as pumps 34, feeders/conveyors 36, and mixers 38. A ready-mix concrete delivery system 40 conveys the freshly made ready-mix to a desired pour point, which may be underwater (e.g., a seabed), a near-shore location, or a land location. The delivery system 40 may include a conduit 42, which may be rigid pipe, or a flexible hose as shown. To capture CO2 emitted during operation of the facility 10, a carbon capture system 50 may be integrated into the facility 10. In one arrangement, the carbon capture system 50 may include one or more offtakes 52, a CO2 capture/liquefaction unit 54, and a CO2 storage/injection unit 56.

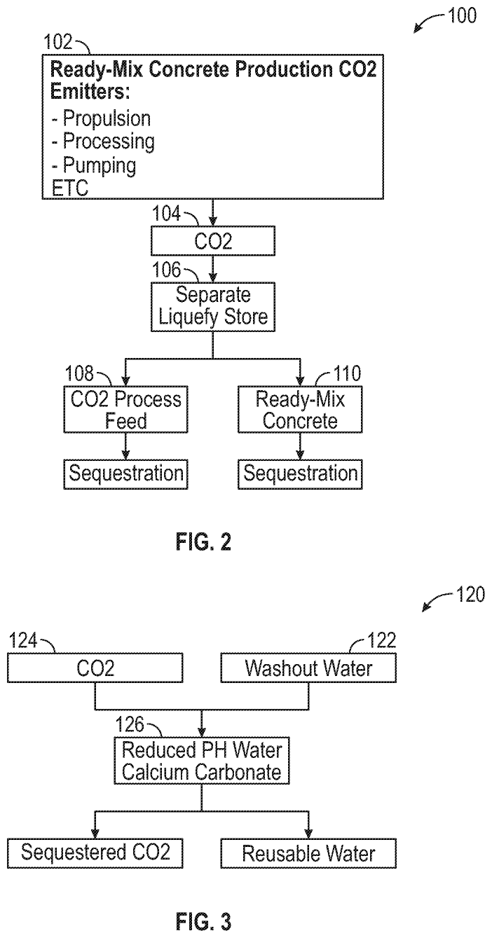

FIG. 2 is a flow chart illustrating one non-limiting embodiment of a method 100 for sequestering CO2 generated by the facility 10 (FIG. 1). Referring to FIGS. 1 and 2, in one illustrative mode of operation, the facility 10 utilizes internal power generation that emits CO2 gases at step 102. In one aspect, the power may be generated by burning hydrocarbon-based fuels. The power may be used to operate a propulsion system, pumps, and other onboard machinery described in connection with FIG. 1.

At step 104, the CO2 emissions are conveyed to the carbon capture system 50 using suitable flow paths, such as the offtake 52 from the power generation system 18. The offtakes 52 may be ducts, tubes, pipes, hoses or other conduits for conveying gases. Similar offtakes (not shown) may be used to convey emissions from other machinery as well. It should be appreciated that the facility 10 uses a “closed” system wherein emissions that include CO2 are collected at the source of the emissions and directed via one or more fluid conduits to the CO2 capture/liquefaction unit 54. In one mode of operation, the flow of emissions from the source may be continuous as long as the source is operating and generating emissions. By “closed” it is meant that there is a structural (e.g., a fluid conduit) and functional (e.g., fluid communication) interconnection between the emission source(s) and the CO2 capture/liquefaction unit 54.

At step 106, the carbon capture system 50 processes these emissions to separate and liquefy the CO2 component of the emissions using the CO2 capture/liquefaction unit 54. The CO2 capture/liquefaction unit 54 separates the CO2 from the emissions. The separated CO2 may be compressed using suitable pumps to a liquid state. The liquefied CO2 may be stored in suitable tanks until needed. Additionally or alternatively, the liquefied CO2 may be used immediately without storage. Also, the CO2 may be stored and/or used in a gaseous state without an intermediate step of liquefaction.

The carbon capture system 50 sequesters the liquefied CO2 in at least one of two ways. For example, at step 108, some or all of the liquefied CO2 gases may be used as a process feed to treat water used to wash surfaces lined with ready-mix cement (“washout water”). At step 110, some or all of the liquefied CO2 gases are scrubbed, processed, cleaned, redirected and combustion gases are separated in order to capture and alienate CO2 which is then contained in gaseous or liquid form, or routed for measured dosing into ready-mix concrete during the mixing process.

FIG. 3 is a flow chart illustrating one non-limiting embodiment of a method 120 for using CO2 as a process feed for treating washout water. When concrete piping and equipment are washed with water, or feed water, the feed water will pick up particulate matter such as sand grains, but will also contain dissolved cement grains, which leads to a high concentration of calcium and silica ions in the water. The calcium ions become balanced by hydroxyl ions, which leads to the water having a high pH (i.e., it becomes very “basic”), making it unsuitable for reuse as concrete mix water. This washout water is received by the carbon capture system 50 at step 122.

At step 124, the carbon capture system 50 receives the separated CO2, which may have been stored. At step 126, the carbon capture system 50 injects the carbon dioxide into concrete washout water. The CO2 reacts with calcium ions in the washout water to precipitate calcium carbonate (that is, calcite or limestone). This serves two purposes: 1) removal of calcium ions from the water reduces the pH closer to neutral, and 2) small calcium carbonate particles could serve as seeding sites for stimulating cement hydration (i.e., the reaction of cement with water). Thus, concrete washout water may, after filtering out larger particles, be made suitable for reuse as concrete mixing water by mixing with CO2. Furthermore, CO2 that reacts with calcium ions to form calcite is essentially permanently bound and unable to be released into the atmosphere since calcite is a very stable mineral, particularly if it is bound in concrete.

It should be understood that the generated CO2 may also be used as a feed for other processes in addition to treating washout water. It should also be understood that the wash water may or may not be used for water in the concrete mixing process. That is, the calcium carbonate or limestone particles may be used for other non-concrete mixing purposes that serve to permanently sequester the CO2.

Referring to FIG. 1, it should be appreciated that the carbon capture system 50 may capture some or all of the CO2 emitted by the shipboard equipment and sequester the CO2 by either or both of using the CO2 to process concrete wash water and injecting the CO2 into the ready mix concrete. It should be appreciated that the carbon capture system 50 may capture and store CO2 separated from the emissions of the power generation system 18 even when ready-mix concrete is not being generated. For example, the power generation system 18 may supply power to a propulsion system that moves the facility 10 between two locations or operated to maintain a position on water while ready-mix concrete generation is interrupted. The CO2 from emissions created during such activity may still be captured by the carbon capture system 50 for use during subsequent ready-mix concrete generation.

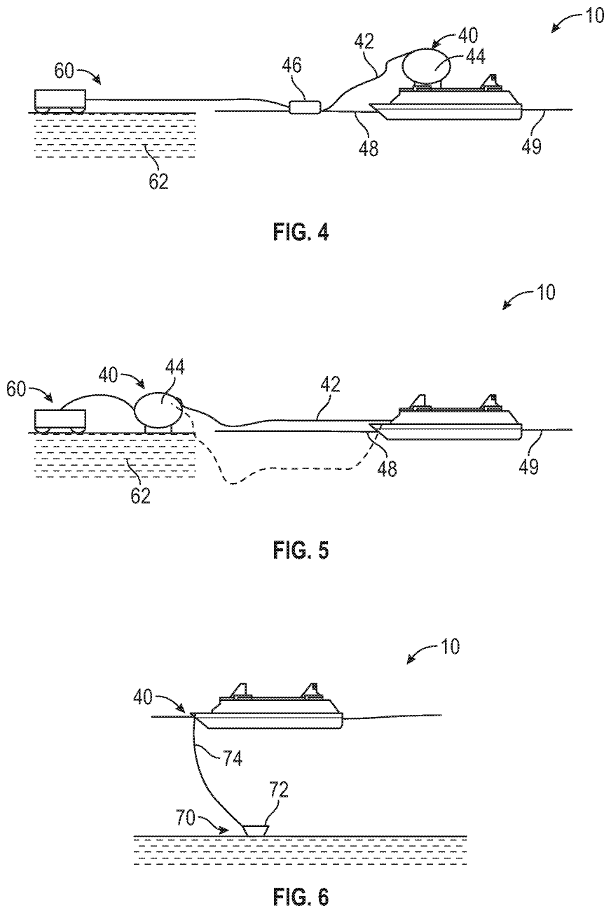

Referring to FIGS. 4-6, there are shown various embodiments of the facility 10 that may use the carbon capture techniques and systems of the present disclosure.

In FIG. 4, the facility 10 is used convey ready-mix concrete to a pour point on land using a ready-mix concrete delivery system 40 that includes a flexible conduit 42 spooled on a reel 44. The reel 44 is positioned at the facility 10. One or more floatation devices 46 may be used to buoy at least a section of the flexible conduit 42 along a surface 48 of the water 49. The conduit 42 may be partially or fully submerged in the water 49 fully above the surface 48.

In FIG. 5, the facility 10 is also used convey ready-mix concrete to a pour point 60 on land 62. In this embodiment, the facility 10 includes a ready-mix concrete delivery system 40 having a flexible conduit 42 spooled on a reel 44 that is positioned at a location on land 62. In this embodiment, a floatation device is not used to buoy the flexible conduit 42 on the water 49. An alternate arrangement may allow the flexible conduit 42, which is shown in hidden lines, to sink below the water's surface 48 or even lay on the sea floor. It should be noted that the arrangements of FIGS. 4 and 5 are interchangeable. That is, the deployment of flexible conduit 42 shown in FIG. 5 may be used in the FIG. 4 embodiment, and vice versa.

Referring to FIGS. 4 and 5, the pour point 60 may be the location for final use of the ready-mix concrete or a location where the ready-mix concrete exiting the conduit 42 is transferred to a secondary transport system. The secondary transport system may include vehicles and/or conduits such as hoses or pipes. Thus, the location for use of the ready-mix concrete may be remote, e.g., up to a kilometer or more from the pour point 60. In some application, the pour point 60 may be on land 62 but the final use may be at an underwater location, such as a seabed or sea floor.

In FIG. 6, the facility 10 is used convey ready-mix concrete to a pour point 70 at a subsea location 72. The ready-mix concrete delivery system 40 includes a conduit 74 that extends from the facility 10. The ready-mix concrete delivery system 40 may use a flexible pipe, reel, and flotation devices as described previously.

Additionally, it should be noted that the source of the CO2 does not necessarily have to be onboard the facility 10. That is, in embodiments of the present disclosure, CO2 from a source external to the facility 10 may be transported to the facility 10 and sequestered into the ready-mix concrete manufactured by the facility 10.

The conduit 42 referred to in FIGS. 1 and 4-6 may be configured as needed for a particular set of operating conditions. The conduit 42 may be formed of mainly rubber or mainly a non-rubber. By mainly, it is meant more than 50%. Additionally, the conduit 42 may be formed of multiple concentric tubular layers. Each layer may have one or more different material properties. For example, the inner most layer that contacts ready-mix concrete may have a lower coefficient of friction and a hardness greater than one or more of the outer layers. Thus, the inner most layer may present less resistance to flow of the ready-mix concrete while providing greater wear resistance. The conduit 42 may be flexible and capable of being stored on a spool, but can alternatively be rigid and formed from telescoping or collapsing parts. The conduit may be a composite bonded pipe, such as the oil and gas downline sold by Airborne™, SHAWCOR, or other comparable product, but can alternatively be a series of rigid sections hinged together, a reinforced rubber pipe, or any other suitable pipe. The conduit may be formed of metals, composites, non-metals, carbon fiber, and/or other materials.

The material making up the conduit 42 depends, in part, on the pressure at which the ready-mix concrete is pumped. For example, a mainly rubber conduit may be adequate for pumping pressure up to 50 bar. For operating pressures above 50 bar, the conduit 42 may be at least partially composed of materials have a burst strength greater than that of rubber. Of course, other factors such as the cross-sectional flow area and the length of the conduit 42 also are factors in determining appropriate material selection.

From the above, it should be appreciated that what has been described include methods of operating a ready-mix concrete production and delivery system. It should be noted that “delivery” as used in connection with the teachings of the present disclosure has two distinct aspects. First, the facility 10 may be moved as needed to shorten the distance between the location at which the ready-mix concrete is made and the location at which the ready-mix concrete is used. Second, the equipment onboard the facility 10 may be used to transport the freshly made-ready mix concrete from the facility 10 to the location at or near where the ready-mix concrete will be used. Thus, aspects of the present disclosure provide systems and related methods that may require less energy, such as from burning fossil fuels, in order to deliver ready-mix concrete.

From the above, it should be appreciated that what has been described includes, in part, a facility configured to manufacture and deliver ready-mix concrete. The facility may include an integrated carbon capture system and a fluid conduit configured to convey emissions from one or more emissions sources to the carbon capture system. Thereafter, the carbon capture system processes the emissions to generate a liquid and/or gas CO2 feed, which may be used immediately and/or stored for later use. The carbon capture system may be in fluid communication with the ready-mix concrete production system via suitable conduits and supply liquid and/or gas CO2 as needed. As noted above, the CO2 may be injected to the ready-mix concrete being produced or to treat the process water from such production. Thus, in one aspect, the facility uses a closed system wherein the carbon capture system is in fluid communication with one or more sources of CO2 emissions and also with one or more receivers of liquid and/or gas CO2. In certain embodiments, the CO2 emission source(s), the CO2 emissions processing equipment, storage, and injection equipment, and the end user(s) of the CO2 are co-located; i.e., located on the same platform and are connected to one another using a fluid conduit network. The platform may be a mobile waterborne platform as illustrated. In other embodiments, the platform may be stationary, either on land or on the water.

Referring to FIG. 1, in certain applications, the carbon capture system 50 may be used in connection with any self-propelled watercrafts in order to capture CO2 from emissions from sources onboard such watercrafts. That is, the teachings of the present disclosure are not limited to only a facility 10 configured for the production and delivery of ready-mix concrete. For example, the carbon capture system 50 may be used on cargo-conveying vessels, passenger vessels, warships, construction vessels, and other such vessels. In such vessels, the carbon capture system 50 may also one or more offtakes 52, a CO2 capture/liquefaction unit 54, and a CO2 storage/injection unit 56. The offtakes 52 may be used to receive emissions from machinery generating power from burning hydrocarbon-based fuels, such as fossil fuels.

Below are definitions for terms used in the present disclosure.

A watercraft refers to any marine vessel that is engineered and constructed to propel itself along a body of water, marine vessel that is engineered to float but does not have onboard equipment for self-propulsion (i.e., an unpowered watercraft), or any marine vessel engineered to be towed or otherwise moved along a body of water.

A waterborne facility refers to any watercraft or floating platform that is engineered and constructed to accommodate heavy equipment such as pumps, hydraulically powered spools, conveyance mechanisms and/or structures such as bins or containers.

The term “near coastal” refers to a region or zone extending inland from a shoreline. Depending on the geography and terrain, a near coastal location can be a few miles or a dozen miles or more from the shoreline.

The term “ready-mix” concrete refers to concrete that is specifically manufactured for delivery to the pour site in a freshly mixed and plastic or unhardened state. Ready-mix concrete may include components such as cement, water and aggregates comprising fine and coarse aggregate. The aggregate may make up at least 50% of a total volume of the ready-mix concrete. In aspects, the volume of aggregate may be 60-75% of a total volume of the ready-mix concrete.

Aggregates may be classified as fine and coarse. Fine aggregates may be defined as being composed of particles, such as natural sand or crushed stone, that have a size allowing passage through a ⅜-inch sieve. Coarse aggregates may be defined as being composed of particles that have a size greater than 0.19 inch in diameter. Conventionally, the size of coarse aggregates fall within the general range of ⅜ inches in diameter to 1.5 inches in diameter.

As a person skilled in the art will recognize from the previous detailed description and from the figures and claims, modifications and changes can be made to the embodiments of the invention without departing from the scope of this invention.

What is claimed is:

1. A method of producing ready-mix concrete, comprising:
positioning a facility on a body of water, the facility being configured to produce and deliver ready-mix concrete, wherein an emission that includes carbon dioxide (CO2) is generated during operation of the facility;
producing the ready-mix concrete at the facility;
generating a process water by using a feed water during production of the ready-mix concrete, the process water including at least calcium and silica ions;
separating the CO2 from the generated emission;
liquefying the separated CO2 by compressing the CO2;
adding at least a first portion of the separated CO2 to the process water; and
adding at least a second portion of the separated CO2 to the ready-mix concrete produced at the facility.

2. The method of claim 1, further comprising moving the facility along the body of water; and wherein:
the emission includes a first emission generated by at least a first emission source while moving the facility and a second emission generated by at least a second emission source while producing the ready-mix concrete;
the step of separating the CO2 from the generated emission includes separating the CO2 from the first emission while the facility is moving; and
the step of liquefying the separated CO2 by compressing the CO2 includes liquefying the CO2 from the first emission while the facility is moving; and
wherein:
the ready-mix concrete is produced by a ready-mix concrete production system; and
the steps of separating the CO2 from the generated emission, liquefying the separated CO2, adding the at least first portion of the separated CO2 to the process water; and adding the at least second portion of the separated CO2 to the ready-mix concrete is done by carbon capture system; and
further comprising:
connecting the carbon capture system to the at least one first emission source and the at least second emission source using a first fluid conduit; and
connecting the carbon capture system the ready-mix concrete system using a second fluid conduit.

3. The method of claim 1, wherein the process water also includes at least cement grains.

4. The method of claim 1, wherein the liquefied CO2 is stored in one or more containers before being added to the process water and the produced ready-mix concrete.

5. The method of claim 1, wherein at least one emission source generates the emission, wherein the at least one emission source is one of: (i) a propulsions system configured to move the facility, and (ii) a ready-mix concrete production system configured to produce the ready-mix concrete.

6. The method of claim 1, further comprising delivering the ready-mix concrete to a pour site that is on land.

7. The method of claim 1, further comprising delivering the ready-mix concrete to a pour site that is underwater.

8. A system for producing and delivery of ready-mix concrete, comprising:
a facility configured to be positioned on a body of water, wherein an emission that includes carbon dioxide (CO2) is generated during operation of the facility;
a ready-mix concrete production system disposed on the facility and configured to produce the ready-mix concrete, the ready-mix concrete production system generating a process water by using a feed water during production of the ready-mix concrete, the process water including at least, calcium, and silica ions;
a ready-mix concrete delivery system configured to deliver the produced ready-mix concrete to a selected pour site; and
a carbon capture system disposed on the vessel, the carbon capture system including:
a least one offtake receiving the emission,
a carbon capture/liquefaction unit configured to separate a CO2 from the received emission and liquefy the separated CO2, and
at least one container configured to store the separated CO2, the carbon capture system being configured to add least a portion of the stored CO2 to the process water, and add at least a portion of the stored CO2 to the ready-mix concrete produced at the facility.

9. The system of claim 8, wherein the facility includes at least one emission source, and further comprising:
a first fluid conduit connecting the at least one emission source to the carbon capture system; and
a second fluid conduit connecting the carbon capture system to the ready-mix concrete production system

10. The system of claim 8, wherein the pour site is on land.

11. The system of claim 8, wherein the pour site is underwater.

12. The system of claim 8, wherein the ready-mix concrete delivery system includes a conduit that extends from the facility.

13. The system of claim 12, wherein the conduit is a flexible hose wound on a reel.

14. A method of operating a ready-mix concrete production and delivery system, comprising:
sequestering at least a portion of a CO2 gas emitted during operation of the ready-mix concrete production and delivery system in at least one of: (i) a ready-mix concrete produced by the ready-mix concrete production and delivery system, and (ii) calcium carbonate formed by processing water used during operation of the ready-mix concrete production and delivery system.
